(19) United States
(12) Patent Application Publication
(10) Pub. No.: US 2007/0024195 A1
(43) Pub. Date: Feb. 1, 2007

(54) Green phosphor and plasma display panel comprising the same

(76) Inventor: Young-Kwan Kim, Chunan-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/496,649

(22) Filed: Jul. 31, 2006

(30) Foreign Application Priority Data
Jul. 29, 2005 (KR) 10-2005-0069461

(51) Int. Cl. H01J 17/49

(52) U.S. Cl. 313/582

(57) ABSTRACT

New green phosphor materials for use with plasma display devices are disclosed. The green phosphor materials incorporates metals substituting zinc silicate oxide as a host material and a doping element selected from the group consisting of Ca, Mg, Sr, Ba, and combinations thereof. The doping element is doped in an amount of 0.1 to 10 mol %.

### CROSS-REFERENCE TO RELATED APPLICATION

This application claims priority to and the benefit of Korean Patent Application No.10-2005-0069461 filed in the Korean Intellectual Property Office on Jul. 29, 2005, the entire content of which is incorporated herein by reference.

### BACKGROUND FIELD

The present invention relates to a green phosphor and a plasma display panel including the same. More particularly, the present invention relates to a green phosphor with a reduced decay time and a plasma display panel including the same.

### DESCRIPTION OF THE RELATED TECHNOLOGY

A plasma display panel (PDP) is a flat display device using a plasma phenomenon, which is also called a gas-discharge phenomenon. This is because a discharge is generated in the device when an electric potential greater than a certain level is applied to two electrodes separated from each other under a gas atmosphere in a non-vacuum state. Such gas-discharge phenomenon is applied to display an image in the plasma display panel.

At present, a generally-used plasma display panel is a reflective alternating current driven plasma display panel. In such plasma display panels, on a rear substrate (hereinafter, referred to as a first substrate), phosphor layers are formed in discharge cells compartmentalized by a barrier rib. On a front substrate (hereinafter, referred to as a second substrate), display electrodes and a dielectric layer covering the display electrodes are disposed.

The most commonly used green phosphor in a plasma display panel is Zn₂SiO₄:Mn²⁺. Zn₂SiO₄:Mn²⁺ has advantages of high brightness and color purity. However, this green phosphor has a relatively long decay time and therefore incurs difficult issues in implementing motion image displays. Also, this green phosphor has a limitation for improving its brightness.

The above information disclosed in this background section is only for enhancement of understanding of the background of the invention and does not constitute an admission of prior art.

### SUMMARY OF CERTAIN INVENTIVE ASPECTS

One aspect of the invention provides a green phosphor comprising a material comprising a zinc silicate oxide matrix doped with at least one dopant selected from the group consisting of Ca, Mg, Sr, and Ba. At least part of the doped zinc silicate oxide matrix contains the at least one dopant in an amount from about 0.1 to about 10 mol % with respect to the total amount of zinc and the at least one dopant.

In the above described green phosphor, zinc may be partially substituted with the at least one dopant in the doped matrix. At least part of the doped zinc silicate oxide matrix may be represented by the formula: Zn₂₍₁₋ₓ₎M₂ₓSiO₄:Mn²⁺. M represents the at least one dopant, wherein x ranges from about 0.001 to about 0.1. In the formula, M may represent two or more dopants, and the two or more dopants may be contained in the matrix in substantially equal or different molar ratios. x of the Formula 1 may range from 0.01 to 0.05. The doped zinc silicate oxide matrix may comprise a portion, in which the at least one dopant is substantially homogeneously distributed. The doped zinc silicate oxide matrix may comprise a portion, in which the at least one dopant is not homogeneously distributed. The above-described green phosphor is to emit green light with decay time of less than or equal to about 9 ms. The green phosphor is to emit green light with decay time ranging from about 3 to about 7 ms. The green phosphor is to emit light having a wavelength in the range of 525 ± about 40 nm. The green phosphor may be used for a plasma display.

Another aspect of the invention provides a plasma display device comprising a green phosphor. The green phosphor comprises a material comprising a zinc silicate oxide matrix, in which zinc is partially substituted with at least one element selected from the group consisting of Ca, Mg, Sr, and Ba. The matrix comprises a portion, in which the at least one element is contained in an amount of about 0.1 to about 10 mol % with respect to the total amount of zinc and the at least one element in the portion.

The above-described plasma display device may further comprise a discharge cell containing the green phosphor; and at least two electrodes associated with the discharge cell and configured to stimulate the discharge cell to generate a plasma discharge within the discharge cell, wherein the plasma discharge is to excite the green phosphor to emit green light. At least part of the matrix may be represented by the following Formula: Zn₂₍₁₋ₓ₎M₂ₓSiO₄:Mn²⁺, wherein M represents the at least one element, wherein x ranges from about 0.001 to about 0.1. The device may further comprise a red phosphor and a blue phosphor.

Another aspect of the invention provides a method of emitting green light. The method comprises: providing a plasma display device comprising a discharge cell containing the above-described green phosphor; and stimulating the plasma display device to create a plasma discharge within the discharge cell, wherein the plasma discharge excites and causes the green phosphor to emit green light. The green light may have a wavelength in the range of 525 ± about 40nm. The green light emission has decay time of less than or equal to about 9 ms. The green light emission has decay time ranging from about 3 to about 7 ms. At least part of the matrix of the green phosphor is represented by the following Formula: Zn₂₍₁₋ₓ₎M₂ₓSiO₄:Mn²⁺, wherein M represents the at least one dopant, wherein x ranges from about 0.001 to about 0.1. M may represent two or more dopants, and the two or more dopants may be contained in the matrix in substantially equal or different molar ratios.

One embodiment of the present invention provides a green phosphor wherein zinc of zinc silicate oxide is substituted by another component, and that has a reduced decay time. Another embodiment of the present invention provides a plasma display panel including the green phosphor. According to an embodiment of the present invention, a green phosphor is provided, in which zinc silicate oxide as a host material and a doping element selected from the group consisting of Ca, Mg, Sr, Ba, and combinations thereof are included. The doping element is doped in an amount of 0.1 to 10 mol %. A plasma display panel that includes the green phosphor is also provided.

### BRIEF DESCRIPTION OF THE DRAWING

The accompanying drawing, which are incorporated in and constitutes a part of the specification, illustrates an embodiment of the invention, and together with the description, serves to explain the principles of the invention, wherein:

FIG. 1 is a partial exploded perspective view showing the structure of a plasma display panel.

### DETAILED DESCRIPTION OF EMBODIMENTS

Embodiments of the present invention will hereinafter be described in detail with reference to the accompanying drawing.

In embodiments of the present invention, zinc of zinc silicate oxide green phosphor (Zn₂SiO₄:Mn²⁺) is substituted by one or more elements such as Ca, Mg, Sr and Ba, resulting in changing the crystalline or lattice structure of the zinc silicate oxide and improving decay time characteristics of the green phosphor.

In the zinc silicate oxide green phosphor (Zn₂SiO₄:Mn²⁺), the activator Mn²⁺ of zinc silicate oxide has a d-d transition. Initial and final states of the transition have the same even function and therefore transition is generally inhibited. However, the electron structure of Mn²⁺ is incomplete, and therefore the inhibited transition may be permitted by circumferential atoms. However, such a transition proceeds relatively slowly, resulting in the decay time of more than about 10 ms.

Although the invention is not bound to any theories, the inventors have thought that reducing the transition may decrease the decay time of the green phosphor. The reduction of such inhibited transition can be implemented by changing environments of the activator, Mn²⁺. This is because the electron structure of the activator Mn²⁺ is significantly affected by its environment.

The green phosphor according to one embodiment of the present invention includes the zinc silicate oxide matrix doped with one or more elements. The candidate dopants that can change the environment of the activator include Ca, Mg, Sr, and Ba. More particularly, the dopants are positioned in some of the zinc sites of the zinc silicate oxide's crystal or lattice matrix.

In some embodiments, only a single element is used as the dopant. In other embodiments, two or more different elements replace zinc in the zinc silicate oxide. In embodiments, the substitution of zinc with one or more dopants ranges in an amount of 0.1 to 10 mol % with reference to the total amount of zinc and the at least one dopant.

In embodiments, the doped green phosphor comprises a portion of the matrix in which the dopants are substantially homogeneously distributed in the crystalline or lattice structure. In some embodiments, the doped green phosphor comprises a portion of the matrix in which the dopants are non-homogeneously distributed in the crystalline or lattice structure.

In other embodiments, the doped green phosphor is represented by the following Formula 1:
Zn₂₍₁₋ₓ₎M₂ₓSiO₄:Mn²⁺ (1)

In the above Formula 1, M is a dopant selected from the group consisting of Ca, Mg, Sr, and Ba. Although the invention is not bound to any theories, the likely explanation is that M substitutes some of Zn of the zinc silicate oxide (Zn₂SiO₄:Mn²⁺) to change a mother-phase structure, which changes the environment of the activator of Mn²⁺ resulting in reduction of decay time of the light emission.

In some embodiments, M represents two or more dopants. In embodiments where two or more dopants are involved, the two or more dopants are contained in the green phosphor in about the same amount or substantially different amounts. In one embodiment, M represents Ca and Mg. The molar ratio of Ca and Mg may vary significantly in actual embodiments.

In the above Formula 1, x represents a doping ratio of M. In some embodiments, the doping ratio may be in the range of about 0.001 to about 0.1. Optionally in other embodiments, the doping ratio ranges about 0.01 to about 0.05. The value of x is greater than about 0.001 is helpful to reduce the decay time of the resulting phosphor. To maintain color purity, it is helpful to make the value of x smaller than about 0.1.

In embodiments, the doped green phosphor have a significantly reduced decay time when compared to the zinc silicate oxide green phosphor (Zn₂SiO₄:Mn²⁺). The doped green phosphor according to some embodiment of the present invention may have decay time of less than or equal to about 9 ms. In other embodiments, the decay time is from about 3, about 4, about 5, about 6, about7 or about 8 ms.

In embodiments, the doped green phosphor may emit light having a wavelength of 525 ± about 40 nm. When the wavelength is less than the above lower limit, it may emit a bluish color, whereas when it is more than the above upper limit, it may emit a reddish color.

When the doped green phosphor according to one embodiment is applied to a green phosphor of a PDP, it showed color coordinates of x=0.245, y=0.727±0.01 measured using CA-100 Plus.

The doped green phosphor of the above Formula 1 may be made in various methods. According to one embodiment, an M precursor (M containing compound(s)), a zinc precursor (Zn containing compound(s)), a silicon precursor (Si containing compound(s)), and a manganese precursor (Mn containing compound(s))are mixed together and a flux is added. The resulting mixture is subjected to heat-treatment to produce the doped green phosphor.

The M-precursor may be selected from the group consisting of an oxide, nitride, nitrate, borate, carbide, chloride, hydroxide, sulfate, sulfide, and carbonate including the element M. Again, M may represents two or more elements in some embodiments. In embodiments, the zinc precursor includes zinc oxide (ZnO) or zinc nitrate (Zn(NO₃)₂), but not limited thereto. In embodiments, the silicon precursor includes silicon oxide or silicon nitride (Si₃N₄), but not limited thereto. In embodiments, the manganese precursor includes manganese oxide (MnO₂), manganese carbonate (MnCO₃), manganese nitride, and manganese chloride (MnCl₂), but not limited thereto. As noted above preparation of the doped green phosphor is not limited the foregoing method.

The embodiment of the present invention provides a plasma display device comprising a green phosphor. The green phosphor comprises a material comprising a zinc silicate oxide matrix, in which zinc is partially substituted with at least one element selected from the group consisting of Ca, Mg, Sr, and Ba. The matrix comprises a portion, in which the at least one element is contained in an amount of about 0.1 to about 10 mol % with respect to the total amount of zinc and the at least one dopant.

The above-described plasma display device may further comprise a discharge cell containing the green phosphor; and at least two electrodes associated with the discharge cell and configured to stimulate the discharge cell to generate a plasma discharge within the discharge cell, wherein the plasma discharge is to excite the green phosphor to emit green light. The green phosphor may be represented by the following Formula: Zn₂₍₁₋ₓ₎M₂ₓSiO₄:Mn²⁺, wherein M represents the at least one element, wherein x ranges from about 0.001 to about 0.1. The device may further comprise a red phosphor and a blue phosphor.

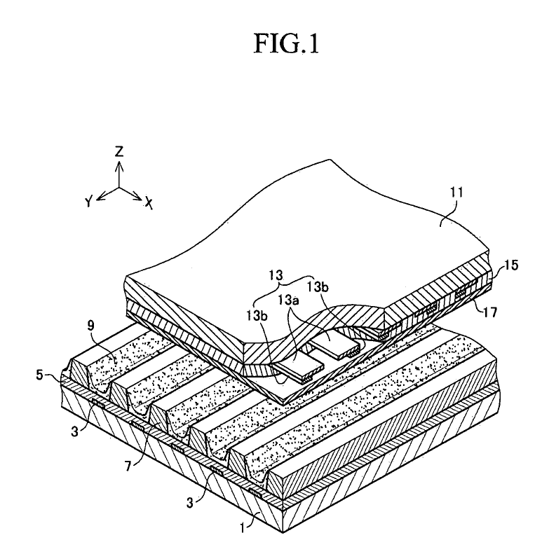

Now an embodiment of a plasma display panel containing the doped green phosphor is discussed. FIG. 1 is a partial perspective view showing an embodiment of the plasma display panel according to the present invention, but the present invention is not limited to the structure shown in FIG. 1. As shown in FIG. 1, on the first substrate 1 of the present inventive plasma display panel, address electrodes 3 are formed along a certain direction (direction Y in the figure), and a dielectric layer 5 is formed on the front surface of the first substrate 1 and over the address electrodes 3. Barrier ribs 7 are disposed on the dielectric layer 5 and may be formed in an open or closed shape. Red (R), green (G), and blue (B) phosphor layers 9 are positioned on a discharge cell between the barrier ribs 7.

On one surface of a second substrate 11 facing the first substrate 1, display electrodes 13 are formed in a direction perpendicular (direction X in the figure) to that of the address electrodes, wherein a discharge sustain electrode 13 is composed of a pair of transparent electrodes 13a and a bus electrode 13b. A transparent dielectric layer 15 and a protection layer 17 are formed over second substrate 11 throughout. These layers 15 and 17 cover the discharge sustain electrodes 13. Thereby, a discharge cell is formed on the cross-section of the address electrode 3 and the display electrode 13 and is filled with discharge gases. Thereby, a discharge cell is formed on the cross-section of the address electrode 3 and the display electrode 13 and is filled with discharge gases.

When an address voltage (Va) is applied between the address electrode 3 and a certain display electrode 13, the address discharge is generated. Further, when a sustain voltage (Vs) is applied between a pair of discharge sustain electrodes 13, vacuum ultraviolet rays generated upon the sustain discharge excite a corresponding phosphor layer 9 to emit visible light though the transparent front surface of the substrate 11. The above plasma display panel includes the doped green phosphor or that represented by the above Formula 1.

The following examples illustrate the present invention in more detail. However, it is understood that the present invention is not limited by these examples.

### EXAMPLE 1

1.998 moles of zinc nitrate (Zn(NO₃)₂), 0.002 moles of calcium nitrate (Ca(NO₃)₂), 1 mole of silicon oxide (SiO₂), and 1 mole of manganese dioxide (MnO₂) were mixed and heat-treated to prepare Zn_{1.998}Ca₀₀₀₂SiO₄:Mn^{2+ where} 0.1 mol % of Zn was substituted with Ca.

A vehicle was made by mixing 6 parts by weight of ethyl cellulose with 100 parts by weight of a mixed solvent of butyl carbitol acetate and terpineol in a mixing ratio of 4:6. 40 parts by weight of the green phosphor was mixed with 100 parts by weight of the vehicle to prepare a phosphor paste.

The resultant phosphor paste was coated on the bottom and side surfaces of a discharge cell compartmentalized by cell barriers of a first substrate to form a green phosphor layer.

Red and blue phosphor layers were formed according to the same manner as the green phosphor layer using a red phosphor of (Y,Gd)BO₃:Eu and a blue phosphor of BaMgAl₁₀O₁₇:Eu, respectively.

A display electrode, a dielectric layer, and a protection layer were formed on a second substrate. The above-fabricated first and second substrates were assembled, sealed, and than out-gassed. Discharge gases were injected and then aging was performed to fabricate a plasma display panel.

In order to measure decay time of light emission from the plasma display panel, a brightness reduction curved line with respect to time during changing a full-green pattern to a full-black pattern was measured using an oscilloscope. Color coordinates and brightness maintenance ratio were measured using color coordinates measuring equipment (CA-100 Plus). The measurement results are shown in Table 1.

### EXAMPLE 2

1.99 moles of zinc nitrate (Zn(NO₃)₂), 0.01 moles of calcium nitrate (Ca(NO₃)₂), 1 mole of silicon oxide (SiO₂), and 1 mole of manganese dioxide (MnO₂) were mixed and heat-treated to prepare Zn_{1.99}Ca_{0.01}SiO₄:Mn²⁺ where 0.5 mol % of Zn was substituted with Ca.

A plasma display panel was fabricated according to the same method as in Example 1, except that the above green phosphor was used. The decay time, color coordinates, and brightness maintenance ratio were measured and the results are shown in Table 1.

### EXAMPLE 3

1.98 moles of zinc nitrate (Zn(NO₃)₂), 0.02 moles of calcium nitrate (Ca(NO₃)₂), 1 mole of silicon oxide (SiO₂), and 1 mole of manganese dioxide (MnO₂) were mixed and heat-treated to prepare Zn_{1.98}Ca_{0.02}SiO₄:Mn²⁺ where 1 mol % of Zn was substituted with Ca.

A plasma display panel was fabricated according to the same method as in Example 1, except that the above green phosphor was used. The decay time, color coordinates, and brightness maintenance ratio were measured and the results are shown in Table 1.

### EXAMPLE 4

1.94 moles of zinc nitrate (Zn(NO₃)₂), 0.06 moles of calcium nitrate (Ca(NO₃)₂), 1 mole of silicon oxide (SiO₂), and 1 mole of manganese dioxide (MnO₂) were mixed and heat-treated to prepare Zn_{1.94}Ca_{0.06}SiO_{4:Mn}²⁺ where 3 mol % of Zn was substituted with Ca.

A plasma display panel was fabricated according to the same method as in Example 1, except that the above green phosphor was used. The decay time, color coordinates, and brightness maintenance ratio were measured and the results are shown in Table 1.

### EXAMPLE 5

1.9 moles of zinc nitrate (Zn(NO₃)₂), 0.1 moles of calcium nitrate (Ca(NO₃)₂), 1 mole of silicon oxide (SiO₂), and 1 mole of manganese dioxide (MnO2) were mixed and heat-treated to prepare Zn_{1.9}Ca_{0.1}SiO₄:Mn²⁺ where 5 mol % of Zn was substituted with Ca.

A plasma display panel was fabricated according to the same method as in Example 1, except that the above green phosphor was used. The decay time, color coordinates, and brightness maintenance ratio were measured and the results are shown in Table 1.

### EXAMPLE 6

1.8 moles of zinc nitrate (Zn(NO₃)²), 0.2 moles of calcium nitrate (Ca(NO₃)₂), 1 mole of silicon oxide (SiO₂), and 1 mole of manganese dioxide (MnO₂) were mixed and heat-treated to prepare Zn_{1.8}Ca_{0.2}SiO₄:Mn²⁺ where 10 mol % of Zn was substituted with Ca.

A plasma display panel was fabricated according to the same method as in Example 1, except that the above green phosphor was used. The decay time, color coordinates, and brightness maintenance ratio were measured and the results are shown in Table 1.

### COMPARATIVE EXAMPLE 1

A plasma display panel was fabricated according to the same method as in Example 1, except that Zn₂SiO₄:Mn²⁺ was used as a green phosphor. The decay time, color coordinates, and brightness maintenance ratio were measured and the results are shown in Table 1.

TABLE 1

| | | | | | Brightness |
|---|---|---|---|---|---|
| | | Ca doping | Decay time | Color | maintenance |
| | Green Phosphor | ratio (%) | (ms) | coordinates | ratio |
| Comparative | Zn₂SiO₄:Mn²⁺ | 0 | 9.0 | 0.254 | 0.727 |
| Example 1 | | | | | |
| Example 1 | Zn_{1.998}Ca_{0.002}SiO₄:Mn²⁺ | 0.1 | 8.6 | 0.254 | 0.727 |
| Example 2 | Zn_{1.99}Ca_{0.01}SiO₄:Mn²⁺ | 0.5 | 8.2 | 0.254 | 0.727 |
| Example 3 | Zn_{1.98}Ca_{0.02}SiO₄:Mn²⁺ | 1 | 7.4 | 0.254 | 0.727 |
| Example 4 | Zn_{1.94}Ca_{0.06}SiO₄:Mn²⁺ | 3 | 6.5 | 0.254 | 0.727 |
| Example 5 | Zn_{1.9}Ca_{0.1}SiO₄:Mn²⁺ | 5 | 4.3 | 0.254 | 0.727 |
| Example 6 | Zn_{1.8}Ca_{0.2}SiO₄:Mn²⁺ | 10 | 4.2 | 0.254 | 0.727 |

### EXAMPLE 7

1.998 moles of zinc nitrate (Zn(NO₃)₂), 0.002 moles of magnesium nitrate (Mg(NO₃)₂), 1 mole of silicon oxide (SiO₂), and 1 mole of manganese dioxide (MnO₂) were mixed and heat-treated to prepare Zn_{1.998}Mg_{0.002}SiO₄:Mn²⁺ where 0.1 mol % of Zn was substituted with Mg.

A plasma display panel was fabricated according to the same method as in Example 1, except that the above green phosphor was used. The decay time, color coordinates, and brightness maintenance ratio were measured and the results are shown in Table 2.

### EXAMPLE 8

1.99 moles of zinc nitrate (Zn(NO₃)₂), 0.01 moles of magnesium nitrate (Mg(NO₃)₂), 1 mole of silicon oxide (SiO₂), and 1 mole of manganese dioxide (MnO₂) were mixed and heat-treated to prepare Zn_{1.99}Mg_{0.01}SiO₄:Mn²⁺ where 0.5 mol % of Zn was substituted with Mg.

A plasma display panel was fabricated according to the same method as in Example 7, except that the above green phosphor was used. The decay time, color coordinates, and brightness maintenance ratio were measured and the results are shown in Table 2.

### EXAMPLE 9

1.98 moles of zinc nitrate (Zn(NO₃)₂), 0.02 moles of magnesium nitrate (Mg(NO₃)₂), 1 mole of silicon oxide (SiO₂), and 1 mole of manganese dioxide (MnO₂) were mixed and heat-treated to prepare Zn_{1.98Mg}_{0.02}SiO₄:Mn²⁺ where 1 mol % of Zn was substituted with Mg.

A plasma display panel was fabricated according to the same method as in Example 7, except that the above green phosphor was used. The decay time, color coordinates, and brightness maintenance ratio were measured and the results are shown in Table 2.

### EXAMPLE 10

1.94 moles of zinc-nitrate (Zn(NO₃)₂), 0.06 moles of magnesium nitrate (Mg(NO₃)₂), 1 mole of silicon oxide (SiO₂), and 1 mole of manganese dioxide (MnO₂) were mixed and heat-treated to prepare Zn_{1.94Mg}_{0.06}SiO₄:Mn²⁺ where 3 mol % of Zn was substituted with Mg.

A plasma display panel was fabricated according to the same method as in Example 7, except that the above green phosphor was used. The decay time, color coordinates, and brightness maintenance ratio were measured and the results are shown in Table 2.

### EXAMPLE 11

1.9 moles of zinc nitrate (Zn(NO₃)₂), 0.1 moles of magnesium nitrate (Mg(NO₃)₂), 1 mole of silicon oxide (SiO₂), and 1 mole of manganese dioxide (MnO₂) were mixed and heat-treated to prepare Zn_{1.9}Mg_{0.1}SiO₄:Mn²⁺ where 5 mol % of Zn was substituted with Mg.

A plasma display panel was fabricated according to the same method as in Example 7, except that the above green phosphor was used. The decay time, color coordinates, and brightness maintenance ratio were measured and the results are shown in Table 2.

### EXAMPLE 12

1.8 moles of zinc nitrate (Zn(NO₃)₂), 0.2 moles of magnesium nitrate (Mg(NO₃)₂), 1 mole of silicon oxide (SiO₂), and 1 mole of manganese dioxide (MnO₂) were mixed and heat-treated to prepare Zn_{1.8}Mg_{0.2}SiO₄:Mn^{2+ where} 10 mol % of Zn was substituted with Mg.

A plasma display panel was fabricated according to the same method as in Example 7, except that the above green phosphor was used. The decay time, color coordinates, and brightness maintenance ratio were measured and the results are shown in Table 2.

TABLE 2

| | | | | | Brightness |
|---|---|---|---|---|---|
| | | Mg doping | Decay time | Color | maintenance |
| | Green Phosphor | ratio (%) | (ms) | coordinates | ratio |
| Comparative | Zn₂SiO₄:Mn²⁺ | 0 | 9.0 | 0.254 | 0.727 |
| Example 1 | | | | | |
| Example 7 | Zn_{1.998}Mg_{0.002}SiO₄:Mn²⁺ | 0.1 | 8.0 | 0.254 | 0.727 |
| Example 8 | Zn_{1.99}Mg_{0.01}SiO₄:Mn²⁺ | 0.5 | 7.1 | 0.254 | 0.727 |
| Example 9 | Zn_{1.98}Mg_{0.02}SiO₄:Mn²⁺ | 1 | 6.5 | 0.254 | 0.727 |
| Example 10 | Zn_{1.94}Mg_{0.06}SiO₄:Mn²⁺ | 3 | 5.3 | 0.254 | 0.727 |
| Example 11 | Zn_{1.9}Mg_{0.1}SiO₄:Mn²⁺ | 5 | 3.2 | 0.254 | 0.727 |
| Example 12 | Zn_{1.8}Mg_{0.2}SiO₄:Mn²⁺ | 10 | 3.1 | 0.254 | 0.727 |

### EXAMPLE 13

1.998 moles of zinc nitrate (Zn(NO₃)₂), 0.001 moles of calcium nitrate (Ca(NO₃)₂), 0.001 moles of magnesium nitrate (Mg(NO₃)₂), 1 mole of silicon oxide (SiO₂), and 1 mole of manganese dioxide (MnO₂) were mixed and heat-treated to prepare Zn_{1.998}Ca_{0.001}Mg_{0.001}SiO₄:Mn²⁺ where 0.1 mol % of Zn was substituted with Ca and Mg.

A plasma display panel was fabricated according to the same method as in Example 1, except that the above green phosphor was used. The decay time, color coordinates, and brightness maintenance ratio were measured and the results are shown in Table 3.

### EXAMPLE 14

1.99 moles of zinc nitrate (Zn(NO₃)₂), 0.005 moles of calcium nitrate (Ca(NO₃)₂), 0.005 moles of magnesium nitrate (Mg(NO₃)₂), 1 mole of silicon oxide (SiO₂), and 1 mole of manganese dioxide (MnO₂) were mixed and heat-treated to prepare Zn_{1.99}Ca_{0.005}Mg_{0.005}SiO₄:Mn²⁺ where 0.5 mol % of Zn was substituted with Ca and Mg.

A plasma display panel was fabricated according to the same method as in Example 13, except that the above green phosphor was used. The decay time, color coordinates, and brightness maintenance ratio were measured and the results are shown in Table 3.

### EXAMPLE 15

1.98 moles of zinc nitrate (Zn(NO₃)₂), 0.01 moles of calcium nitrate (Ca(NO₃)₂), 0.01 moles of magnesium nitrate (Mg(NO₃)₂), 1 mole of silicon oxide (SiO₂), and 1 mole of manganese dioxide (MnO₂) were mixed and heat-treated to prepare Zn1.98Ca_{0.01}Mg_{0.01}SiO₄:Mn²⁺ where 1 mol % of Zn was substituted with Ca and Mg.

A plasma display panel was fabricated according to the same method as in Example 13, except that the above green phosphor was used. The decay time, color coordinates, and brightness maintenance ratio were measured and the results are shown in Table 3.

### EXAMPLE 16

1.94 moles of zinc nitrate (Zn(NO₃)₂), 0.03 moles of calcium nitrate (Ca(NO₃)₂), 0.03 moles of magnesium nitrate (Mg(NO₃)₂), 1 mole of silicon oxide (SiO₂), and 1 mole of manganese dioxide (MnO₂) were mixed and heat-treated to prepare Zn_{1.94}Ca_{0.03}Mg_{0.03}SiO₄:Mn²⁺ where 3 mol % of Zn was substituted with Ca and Mg.

A plasma display panel was fabricated according to the same method as in Example 13, except that the above green phosphor was used. The decay time, color coordinates, and brightness maintenance ratio were measured and the results are shown in Table 3.

### EXAMPLE 17

1.99 moles of zinc nitrate (Zn(NO₃)₂), 0.05 moles of calcium nitrate (Ca(NO₃)₂), 0.05 moles of magnesium nitrate (Mg(NO₃)₂), 1 mole of silicon oxide (SiO₂), and 1 mole of manganese dioxide (MnO₂) were mixed and heat-treated to prepare Zn_{1.9}Ca_{0.05Mg}_{0.05}SiO₄:Mn²⁺ where 5 mol % of Zn was substituted with Ca and Mg.

A plasma display panel was fabricated according to the same method as in Example 13, except that the above green phosphor was used. The decay time, color coordinates, and brightness maintenance ratio were measured and the results are shown in Table 3.

### EXAMPLE 18

1.8 moles of zinc nitrate (Zn(NO₃)₂), 0.1 moles of calcium nitrate (Ca(NO₃)₂), 0.1 moles of magnesium nitrate (Mg(NO₃)₂), 1 mole of silicon oxide (SiO₂), and 1 mole of manganese dioxide (MnO₂) were mixed and heat-treated to prepare Zn_{1.8}Ca_{0.1}Mg_{0.1}SiO₄:Mn²⁺ where 10 mol % of Zn was substituted with Ca and Mg.

A plasma display panel was fabricated according to the same method as in Example 13, except that the above green phosphor was used. The decay time, color coordinates, and brightness maintenance ratio were measured and the results are shown in Table 3.

TABLE 3

| | | Doping | | | Brightness |
|---|---|---|---|---|---|
| | | ratio of | Decay time | Color | maintenance |
| | Green Phosphor | Mg and Ca | (ms) | coordinates | ratio |
| Comparative | Zn₂SiO₄:Mn²⁺ | 0 | 9.0 | 0.254 | 0.727 |
| Example 1 | | | | | |
| Example 13 | Zn_{1.998}Ca_{0.001} Mg_{0.001}SiO₄:Mn²⁺ | 0.1 | 8.1 | 0.254 | 0.727 |
| Example 14 | Zn_{1.99}Ca_{0.005} Mg_{0.005}SiO₄:Mn²⁺ | 0.5 | 7.3 | 0.254 | 0.727 |
| Example 15 | Zn_{1.98}Ca_{0.01} Mg_{0.01}SiO₄:Mn²⁺ | 1 | 6.6 | 0.254 | 0.727 |
| Example 16 | Zn_{1.94}Ca_{0.03} Mg_{0.03}SiO₄:Mn²⁺ | 3 | 5.4 | 0.254 | 0.727 |
| Example 17 | Zn_{1.9}Ca_{0.05} Mg_{0.05}SiO₄:Mn²⁺ | 5 | 3.3 | 0.254 | 0.727 |
| Example 18 | Zn_{1.8}Ca_{0.1} Mg_{0.1}SiO₄:Mn²⁺ | 10 | 3.2 | 0.254 | 0.727 |

As shown in Tables 1 to 3, the doped green phosphors according to embodiments of the present invention have significantly shorter decay time than Zn₂SiO₄:Mn²⁺ while showing similar color coordinates to Zn₂SiO₄:Mn²⁺. The use of the doped green phosphors according to embodiments of the invention in plasma display devices will improve the decay time for green light emission and therefore improve the performance when display motion images.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A green phosphor comprising:
a material comprising a zinc silicate oxide matrix doped with at least one dopant selected from the group consisting of Ca, Mg, Sr, and Ba, wherein at least part of the doped zinc silicate oxide matrix contains the at least one dopant in an amount from about 0.1 to about 10 mol % with respect to the total amount of zinc and the at least one dopant.

2. The green phosphor of claim 1, wherein zinc is partially substituted with the at least one dopant in the doped zinc silicate oxide matrix.

3. The green phosphor of claim 1, wherein at least part of the doped zinc silicate oxide matrix is represented by the following Formula 1:
Zn₂₍₁₋ₓ₎M₂ₓSiO₄:Mn²⁺ (1),
wherein M represents the at least one dopant, wherein x ranges from about 0.001 to about 0.1.

4. The green phosphor of claim 3, wherein M represents two or more dopants, and wherein the two or more dopants are contained in the matrix in substantially equal or different molar ratios.

5. The green phosphor of claim 3, wherein x of the Formula 1 ranges from 0.01 to 0.05.

6. The green phosphor of claim 1, wherein the doped zinc silicate oxide matrix comprises a portion, in which the at least one dopant is substantially homogeneously distributed.

7. The green phosphor of claim 1, wherein the doped zinc silicate oxide matrix comprises a portion, in which the at least one dopant is not homogeneously distributed.

8. The green phosphor of claim 1, wherein the green phosphor is to emit green light with decay time of less than or equal to about 9 ms.

9. The green phosphor of claim 1, wherein the green phosphor is to emit green light with decay time ranging from about 3 to about 7 ms.

10. The green phosphor of claim 1, wherein the green phosphor is to emit light having a wavelength in the range of 525± about 40 nm.

11. The green phosphor of claim 1, which is used for a plasma display.

12. A plasma display device comprising a green phosphor,
wherein the green phosphor comprises a material comprising a zinc silicate oxide matrix, in which zinc is partially substituted with at least one element selected from the group consisting of Ca, Mg, Sr, and Ba, and
wherein the matrix comprises a portion, in which the at least one element is contained in an amount of about 0.1 to about 10 mol % with respect to the total amount of zinc and the at least one element in the portion.

13. The plasma display device of claim 12, further comprising:
a discharge cell containing the green phosphor; and
at least two electrodes associated with the discharge cell and configured to stimulate the discharge cell to generate a plasma discharge within the discharge cell, wherein the plasma discharge is to excite the green phosphor to emit green light.

14. The plasma display device of claim 13, wherein at least part of the matrix is represented by the following Formula 1:
Zn₂₍₁₋ₓ₎M₂ₓSiO₄:Mn²⁺ (1),
wherein M represents the at least one element, wherein x ranges from about 0.001 to about 0.1.

15. The plasma display device of claim 13, further comprising a red phosphor and a blue phosphor.
